(19) United States
(12) Patent Application Publication
(10) Pub. No.: US 2026/0270419 A1
(43) Pub. Date: Sep. 10, 2026

(54) Wiener Filter Design For Video Coding

(71) Applicant: GOOGLE LLC, Mountain View, CA (US)

(72) Inventors: Jianle Chen, San Diego, CA (US); Onur Guleryuz, San Francisco, CA (US); Debargha Mukherjee, Cupertino, CA (US)

(21) Appl. No.: 19/156,675

(22) PCT Filed: Feb. 13, 2024
(86) PCT No.: PCT/US2024/015505

§ 371 Date: Aug. 14, 2025

Related U.S. Application Data
(60) Provisional application No. 63/485,233, filed on Feb. 15, 2023.

(51) Int. Cl. H04N 19/117; H04N 19/186; H04N 19/70

(52) U.S. Cl. CPC H04N 19/117; H04N 19/186; H04N 19/70

(57) ABSTRACT

A reconstructed frame is generated by decoding an encoded frame from a compressed bitstream. The reconstructed frame includes a first color plane and a second color plane. An enhanced reconstructed frame is obtained by applying a filter to at least one pixel of the first color plane of the reconstructed frame using at least one pixel value of the second color plane.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

Encoding based on motion estimation and compensation may be performed by breaking frames or images into blocks that are predicted based on one or more prediction blocks of reference frames. Differences (i.e., residual errors) between blocks and prediction blocks are compressed and encoded in a bitstream. A decoder uses the differences and the reference frames to reconstruct the frames or images.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method. The method includes generating a reconstructed frame by decoding an encoded frame from a compressed bitstream, where the reconstructed frame may include a first color plane and a second color plane. The method also includes obtaining an enhanced reconstructed frame by applying a filter to at least one pixel of the first color plane of the reconstructed frame using at least one pixel value of the second color plane. Other embodiments of this aspect include corresponding computer systems, apparatus, and computer programs recorded on one or more computer storage devices, each configured to perform the actions of the methods.

Implementations may include one or more of the following features. The method where the first color plane has a lower resolution than the second color plane, and where applying the filter to the at least one pixel of the first color plane of the reconstructed frame using the at least one pixel value of the second color plane may include obtaining a down-sized second color plane by down-sizing the second color plane, where the at least one pixel value is a pixel of the down-sized second color plane.

In some implementations, obtaining the enhanced reconstructed frame by applying the filter may include applying a first filter to the first color plane to obtain an intermediate filtered color plane; and applying the filter to the intermediate filtered color plane to obtain the enhanced reconstructed frame.

In some implementations, the first filter uses symmetric weights, and the filter uses anti-symmetric weights.

In some implementations, obtaining the enhanced reconstructed frame by applying the filter may include applying a first filter to the first color plane to obtain a first intermediate filtered color plane, where the first filter uses first symmetric weights; applying a second filter to the first intermediate filtered color plane to obtain a second intermediate filtered color plane, where the second filter is applied to at least one pixel of the first intermediate filtered color plane using the at least one pixel value of the second color plane, and where the second filter uses second symmetric weights; and applying the filter to the second intermediate filtered color plane to obtain the enhanced reconstructed frame, where the filter uses anti-symmetric weights.

In some implementations, the method may include coding a syntax element indicating to apply the filter.

In some implementations, the method may include coding weights for the filter.

In some implementations, the method may include coding a syntax element indicating whether the filter is a symmetric or an anti-symmetric filter.

In some implementations, the method may include coding a syntax element indicating to apply a symmetric filter and to apply an anti-symmetric filter.

In some implementations, the first color plane is a luminance plane, and the second color plane is a chrominance blue plane. In some implementations, the first color plane is a luminance plane, and the second color plane is a chrominance red plane.

An aspect may include a non-transitory computer-readable storage having stored thereon an encoded bitstream that is configured for decoding by one of the aspects or methods described above. Another aspect may include a non-transitory computer-readable storage having stored thereon an encoded bitstream that is generated by an encoder performing one of the aspects or methods described above.

These and other aspects of the present disclosure are disclosed in the following detailed description of the embodiments, the appended claims, and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is an illustration of examples of portions of a video frame.

FIG. 7 is a diagram that illustrates the operations of a Weiner filter.

FIG. 8 is an example of a flowchart of a technique for filtering pixel values of one color plane using pixels of other color planes.

FIG. 9 is an example of a flowchart of a technique for filtering pixel values of one color plane using pixels of other color planes.

FIG. 10 illustrates examples of down-sizing a frame. Specifically, the examples shown illustrate down-sampling.

### DETAILED DESCRIPTION

Video compression codecs operate under many structural design constraints primarily to enable computational efficiencies. Important among these are block-based processing and block-based transforms. It is well known that these constraints lead to visible artifacts after compression. Over the years many restoration tools have been developed to improve quality with some tools managing to improve both objective and subjective quality. Such tools are incorporated at the output of the compression codec in a way to (i) improve the rendering of the current video frame and (ii) function within the compression loop to help the prediction of the subsequent frames. Restoration tools designed to perform deblocking and/or reduce blocking artifacts improve quality at block boundaries; and restoration tools designed to reduce ringing artifacts improve quality over (around) edges.

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities can be known as inter prediction. Inter prediction can attempt to predict the pixel values of a block using a possibly displaced block or blocks from a temporally nearby frame (i.e., reference frame) or frames. A temporally nearby frame is a frame that appears earlier or later in time in the video stream than the frame of the block being encoded. A prediction block resulting from inter prediction is referred to herein as inter predictor.

Inter prediction is performed using a motion vector (MV). A motion vector used to generate a prediction block refers to a frame other than a current frame, i.e., a reference frame. Reference frames can be located before or after the current frame in the sequence of the video stream. Some codecs may use up to eight reference frames, which can be stored in frame buffers of a reference frame store. The motion vector can refer to (i.e., use) one of the reference frames stored in the reference frame store. Reference frames stored in the reference frame store can also be used to generate motion fields.

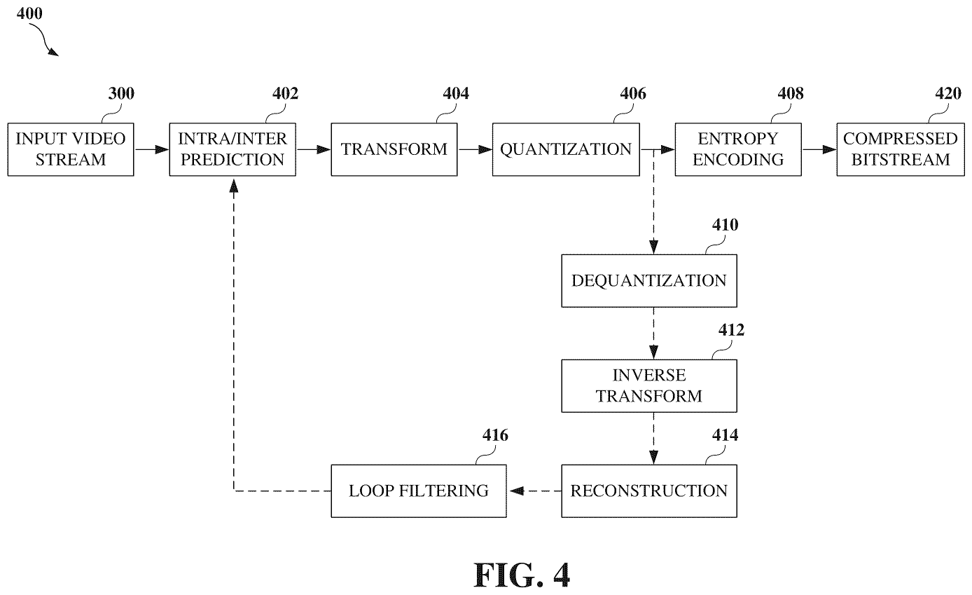

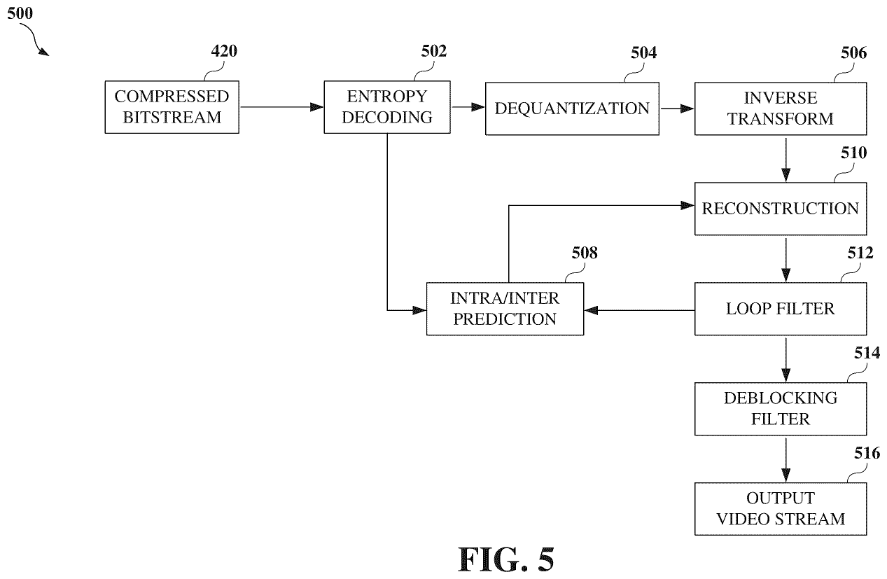

Residuals (i.e., differences) can be encoded using a lossy quantization step. Decoding (i.e., reconstructing) from such residuals often results in distortion or artefacts (e.g., ringing artefacts or blockiness artefacts) in the reconstructed data. The encoder and decoder may perform operations that improve the quality of the reconstructed data, such as described below with respect to a loop filtering stage 416 of FIG. 4 and a loop filtering stage 512 of FIG. 5 (e.g., within the reconstruction loop at the encoder or prior the outputting at the decoder). Loop restoration may be performed to process a reconstructed video frame for use as a reference frame.

A filtering stage (e.g., a post-processing and/or an in-loop filtering stage) may include multiple restoration tasks (i.e., operations or tools) that are applied to a reconstructed frame of a current frame to improve the quality of the reconstructed frame. For example, the Alliance for Open Media (AOMedia) AV1 codec includes a deblocking filter, a constrained directional enhancement filter (CDEF), and a loop restoration filter, which are briefly described herein. A reconstructed frame is the frame that results from the process of decoding, such as by a decoder, an encoded frame, such as from a compressed bitstream.

The deblocking filter can be applied across transform block boundaries to remove block artifacts caused by the quantization error. The CDEFs perform edge direction searching at an 8×8 block-level. In CDEFs, eight edge directions are identified within blocks according to edge templates. A primary filter processes reconstruction samples along the edge direction while a secondary filter processes reconstruction samples along a direction 45-degrees from the edge direction. The loop restoration filter is applied to units of either 64×64-, 128×128-, or 256×256-pixel blocks, named loop restoration units (LRU). Bypass filtering, a Wiener filter, or a self-guided filter can be independently selected for each LRU. The self-guided filter scheme applies simple filters to reconstructed pixels, X, to generate two denoised versions, X₁ and X₂; their differences from the reconstructed pixels, (X₁-X) and (X₂-X), are used to span a sub-space, upon which the differences between the reconstructed pixels and the original pixels, (Xₛ-X) are projected.

The Wiener filter of the AV1 codec is a 7×7 separable filter that includes a 7-tap vertical filter and a 7-tap horizontal filter. Filtering of the reconstruction samples of a block can be performed by applying the vertical and horizontal filters sequentially. After applying the vertical and horizontal filters, the final filtered reconstruction samples are generated. The decoded frame pixel values (at (p, q) and a k×k neighbourhood of the pixel) are used to filter to obtain a filtered frame value at corresponding pixels. The process can be formulated as shown in equation (1)

$$\hat{x} ( p , q ) = {\sum }_{m , n = - k / 2}^{( k + 1 ) / 2 - 1} x ( p + m , q + n ) * {f}^{( p , q )} ( m , n ) \qquad ( 1 )$$

In equation (1), (p, q) indicates a location of a pixel of an image or video frame, and f^{(p,q)}(m, n) are the filter coefficients for its k×k neighbourhood. The filter coefficients can be derived by an encoder and signaled to a decoder in a compressed bitstream. Alternatively, a set of filters may be pre-defined and stored at both an encoder and a decoder, and predefined logic can be used to select one of the filters for a pixel or block at both the encoder and the decoder. Some other shape of the neighborhood, such as a diamond shape, may be used instead of the rectangle or square (i.e., k×k) shape.

The self-guided filtering tool described above composes pixel-adaptive filters and affects them but does not utilize side information that may help the self-guided filter tool signal and use more beneficial filters. On the other hand, the Wiener filtering tool signals filters using side information but does not adapt the filter per-pixel.

As further described herein, a frame (or image) can be composed of several color planes (or components). For example, in the YUV color space, which is the most popular in the field of image and video compression, an image can be composed into or include a color luminance Y, chrominance blue (Cb), and chrominance red (Cr) color planes.

Conventionally, pixels of one color component are filtered using pixels of that same color components. That is, the luminance (Y) pixels may be filtered using other luminance pixels; the Cb pixels may be filtered using other Cb pixels; and the Cr pixels are filtered using other Cr pixels.

Implementations of this disclosure provide a loop-filtering (i.e., a loop restoration filtering) tool that utilizes pixel-adaptive filters and signaling beneficial filters through side information (e.g., data related to filtering and transmitted in a compressed bitstream). As becomes clearer from the description herein, the disclosed loop filtering may be considered most directly related to the Wiener filter described above, and as such, the disclosure herein is referred to as improved Wiener filtering. The improved Wiener filter can use pixel values of one or more color components as inputs to (i.e., when applying the Wiener filter to) a pixel of another color component.

The Weiner filter process is expressed by using the difference of the neighboring pixel values and the current pixel value as inputs, as shown in equation (2):

$$\hat{x} ( p , q ) = x ( p , q ) + {\sum }_{m , n = - k / 2}^{( k + 1 ) / 2 - 1} ( x ( p + m , q + n ) - x ( p , q ) ) * {f}^{( p , q )} ( m , n ) \qquad ( 2 )$$

In some implementations, symmetric Wiener filters can be used to reduce the bit overhead associated with filter coefficient signaling as well as to reduce the computational complexity of the filtering process. As such, only three coefficients need to be signaled for a 7-tap filter, with the three mirrored coefficients derived as the same values. That is, in the symmetric filter, the value of f^{(p,q)}(m, n) is equal to f^{(p,q)}(−m, −n).

To illustrate the application of equation (2), and using the chrominance Cb pixels as an example, the Cb pixel values can be filtered using Cb pixel values of the neighborhood as inputs, as shown in equation (3):

$$\text{?} ( p , q ) = Cb ( p , q ) + {\sum }_{m , n = - k / 2}^{( k + 1 ) / 2 - 1} ( Cb ( p + m , q + n ) - Cb ( p , q ) ) * {f}_{Cb}^{( p , q )} ( m , n ) \qquad ( 3 )$$

In equation (3), Cb(p, q) is an original value of the chrominance blue component at the pixel location (p, q); [symbol] (p, q) is the new (e.g., updated) value of the chrominance blue component at the pixel location (p, q);

$${\sum }_{m , n = - k / 2}^{( k + 1 ) / 2 - 1} ( )$$

is a summation over a window of size k×k and centered around the pixel (p, q), where m and n iterate over the range of the window; (Cb(p+m,q+n)−Cb(p,q)) is the difference between the value of the chrominance component at a neighboring pixel (p+m, q+n) and the original pixel (p, q) representing a local difference or gradient at each point in the window; and

$${f}_{Cb}^{( p , q )} ( m , n )$$

is a filter function (e.g., a set of weights) applied to the chrominance component, which could be a weighting function that depends on the pixel location (p, q) and the position within the window (m, n).

To further improve restoration efficiency, the improved Wiener filters may use the pixel values of other components as additional inputs or alternative inputs when applying the filter to a pixel of a color plane. For example, since the luminance (Y) component is the most dominant of the color components, the luminance (Y) component pixel values in respective collocated neighborhoods may be used to update (e.g., filter) the values of at least one of the Cb or Cr chrominance component pixels. When the filter is applied in YUV 4:2:2 and YUV 4:2:0 color format video, the Y plane may be sub-sampled or down-sampled before being used in the filtering process.

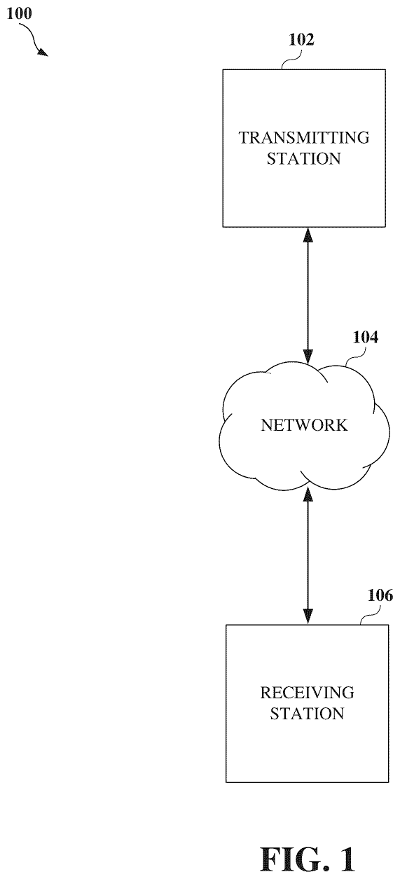

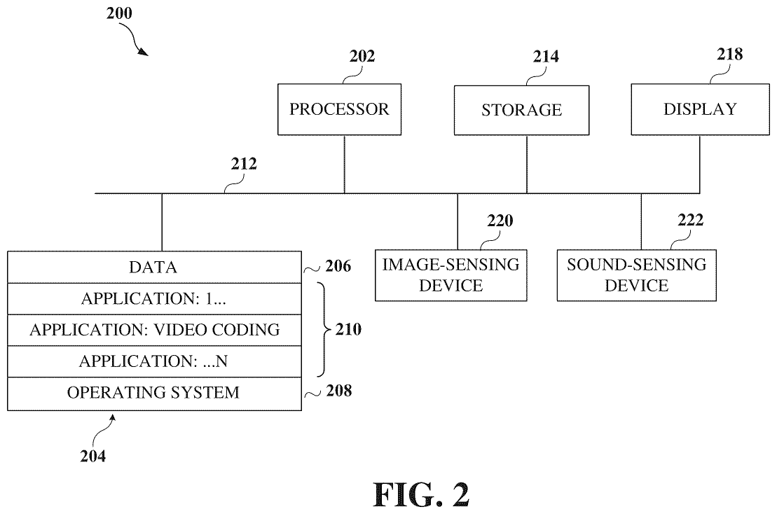

Further details of techniques for improved Wiener filtering are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown (e.g., the CPU 202), advantages in speed and efficiency can be achieved by using more than one processor.

A memory 204 in computing device 200 can be a read-only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described herein. For example, the application programs 210 can include applications 1 through N, which further include a video coding application that performs the techniques described here, such as the techniques for improved Wiener filtering. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

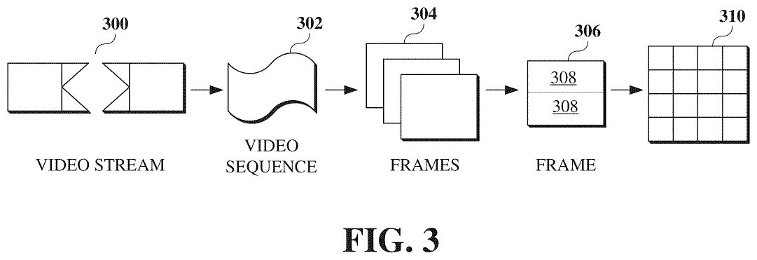

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

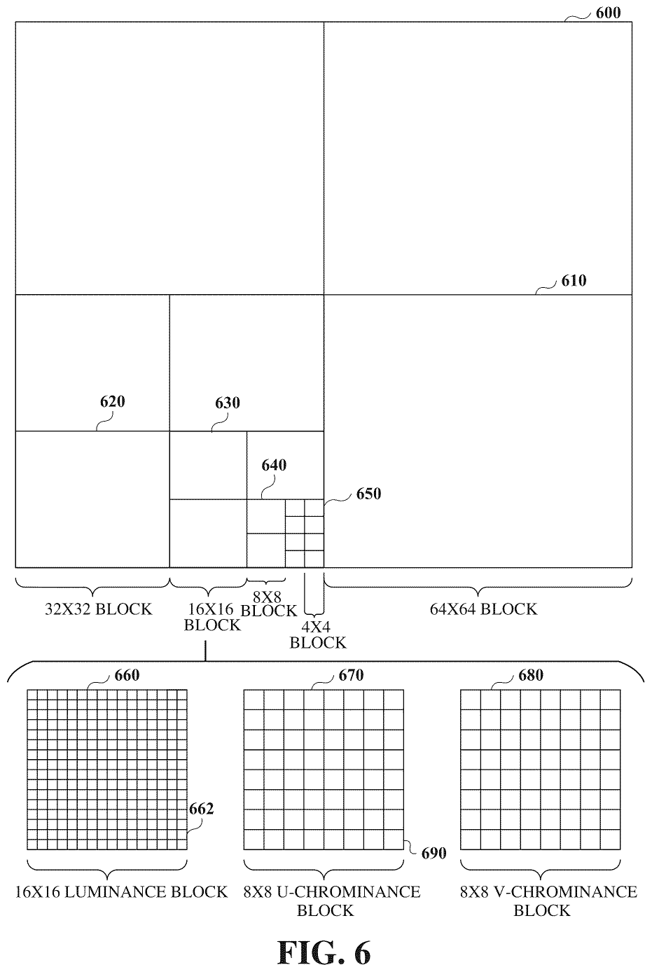

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. Implementations for forming a prediction block are discussed below with respect to FIGS. 6, 7, and 8, for example, using parameterized motion model identified for encoding a current block of a video frame.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block (which may include, for example, the type of prediction used, transform type, motion vectors and quantizer value), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 is applied to the reconstructed block to reduce blocking distortion or perform other post-processing on a frame, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

FIG. 6 is an illustration of examples of portions of a video frame 600, which may, for example, be the frame 306 shown in FIG. 3. The video frame 600 includes a number of 64×64 CTUs, such as four 64×64 CTUs 610 in two rows and two columns in a matrix or Cartesian plane, as shown. Each 64×64 CTU 610 may include up to four 32×32 CUs 620. Each 32×32 CU 620 may include up to four 16×16 CUs 630. Each 16×16 CU 630 may include up to four 8×8 CUs 640. Each 8×8 CU 640 may include up to four 4×4 CUs 650. Each 4×4 CU 650 may include 16 pixels, which may be represented in four rows and four columns in each respective CU in the Cartesian plane or matrix.

In some implementations, the video frame 600 may include CTUs larger than 64×64 and/or CUs smaller than 4×4. Subject to features within the video frame 600 and/or other criteria, the video frame 600 may be partitioned into various arrangements. Although one arrangement of CUs is shown, any arrangement may be used. Although FIG. 6 shows N×N CTUs and CUs, in some implementations, N×M CTUs and/or CUs may be used, wherein N and M are different numbers. For example, 32×64 CTUs, 64×32 CTUs, 16×32 CUs, 32×16 CUs, or any other size may be used. In some implementations, N×2N CTUs or CUs, 2N×N CTUs or CUs, or a combination thereof, may be used.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown.

In some implementations, coding the video frame 600 may include ordered block-level coding. Ordered block-level coding may include coding CUs of the video frame 600 in an order, such as raster-scan order, wherein CUs may be identified and processed starting with a CTU in the upper left corner of the video frame 600, or portion of the video frame 600, and proceeding along rows from left to right and from the top row to the bottom row, identifying each CU in turn for processing. For example, the 64×64 CTU in the top row and left column of the video frame 600 may be the first CTU coded and the 64×64 CTU immediately to the right of the first CTU may be the second CTU coded. The second row from the top may be the second row coded, such that the 64×64 CTU in the left column of the second row may be coded after the 64×64 CTU in the rightmost column of the first row.

In some implementations, coding a CTU of the video frame 600 may include using quad-tree coding, which may include coding smaller CUs within a CTU in raster-scan order. For example, the 64×64 CTU shown in the bottom left corner of the portion of the video frame 600 may be coded using quad-tree coding wherein the top left 32×32 CU may be coded, then the top right 32×32 CU may be coded, then the bottom left 32×32 CU may be coded, and then the bottom right 32×32 CU may be coded. Each 32×32 CU may be coded using quad-tree coding wherein the top left 16×16 CU may be coded, then the top right 16×16 CU may be coded, then the bottom left 16×16 CU may be coded, and then the bottom right 16×16 CU may be coded. Each 16×16 CU may be coded using quad-tree coding wherein the top left 8×8 CU may be coded, then the top right 8×8 CU may be coded, then the bottom left 8×8 CU may be coded, and then the bottom right 8×8 CU may be coded. Each 8×8 CU may be coded using quad-tree coding wherein the top left 4×4 CU may be coded, then the top right 4×4 CU may be coded, then the bottom left 4×4 CU may be coded, and then the bottom right 4×4 CU may be coded. In some implementations, 8×8 CUs may be omitted for a 16×16 CU, and the 16×16 CU may be coded using quad-tree coding wherein the top left 4×4 CU may be coded, then the other 4×4 CUs in the 16×16 CU may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of luma samples, and by two lower resolution chrominance components, each of which represents the portion of the image as an 8×8 block of chroma samples. A sample may indicate a value, for example, a value in the range from 0 to 255, and may be stored or transmitted using, for example, eight bits. Although this disclosure is described in reference to the YUV color model, another color model may be used. Reducing spatial redundancy may include transforming a CU into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values and/or luma and chroma samples may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

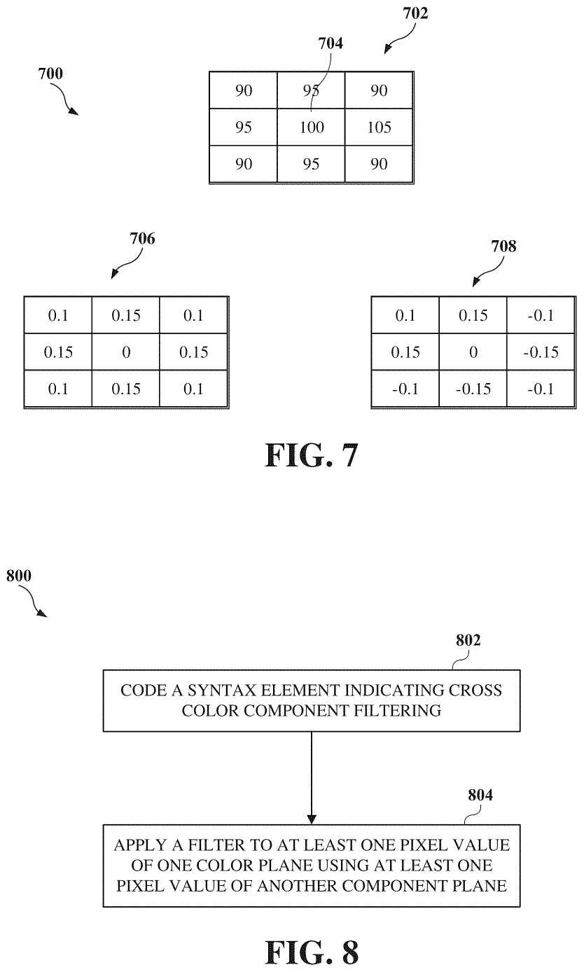

FIG. 7 is a diagram 700 that illustrates the operations of a Weiner filter. The Weiner filter may be designed to minimize the mean square error between the estimated and the true desired image. In the context of video coding, the Weiner filter is applied to reconstructed frames to enhance their quality and bring them closer to their respective source frames by reducing artifacts and noise introduced during the compression and decompression processes. It is noted that the pixel values and weight values used with respect to FIG. 7 have no particular significance. They are merely illustrative.

As already mentioned, during video coding, each frame is compressed to reduce bandwidth or storage requirements, which often introduces compression artifacts and noise. More specifically, each color plane may be separately encoded (e.g., compressed). After decompression (such as of each color plane), the reconstructed frame is not an exact replica of the original frame due, at least, to these artifacts. Applying Weiner filters, as described herein, with appropriate symmetric or anti-symmetric weights to the reconstructed frames can significantly reduce these imperfections. The Weiner filter operates by adjusting the frequency components of the video signal based on the signal-to-noise ratio (SNR) across the signal. This adjustment is performed using a set of filter weights, which are determined based on the characteristics of the video signal and are designed (e.g., calculated, selected, or the like) to minimize the mean square error. The goal of applying a Wiener filter is to produce a reconstructed frame that is as close as possible to the original frame prior to compression.

In an example, both an encoder, such as the encoder 400 of FIG. 4, and a decoder, such as the decoder 500 of FIG. 5, may include pre-designed filters with fixed filter weights, which may be stored in a lookup table (e.g., codebooks). The encoder may transmit an index into the lookup table that the decoder uses to retrieve the filter weights from the lookup table. In another example, the encoder may transmit the filter weights to the decoder. In either case, the encoder is said to transmit (e.g., signal) the weights to the decoder.

In an example, the encoder may perform the steps of noise estimation, filter weight calculation, applying the filter to the reconstructed frames, and transmission of the weights to the decoder. The noise estimation process may involve analyzing a reconstructed frame to determine the nature and extent of the noise present. Noise, in this context, can mean the level of divergence of the reconstructed frame from its source frame. Based on this analysis, the filter weights are calculated to achieve the best noise reduction while preserving the essential details of the frame. The calculated Weiner filter is applied to the reconstructed frame to produce an enhanced version of the frame (referred to herein as an enhanced reconstructed frame). The encoder transmits the weights to the decoder, which applies the Weiner filer to the reconstructed frame obtained at the decoder to generate the enhanced reconstructed frame.

The diagram 700 illustrates a neighborhood 702 of a current pixel 704 and a set of weights 706 associated respectively with the pixel locations of the neighborhood 702. The neighborhood 702 can be a portion of a reconstructed frame. Each pixel location of the neighborhood 702 is associated with a distinct weight of the set of weights 706 based on its contribution to the target pixel's new value. The set of weights 706 are to be used in a filtering operation, as described herein. Again, the weights may be determined by an encoder by optimizing the filter to minimize the mean square error between the estimated image and the original image. A filtered value pixel \hat{x} for the pixel 704 can be obtained using, for example, one of equations (2) or (3), to obtain \hat{x}=94.5, which may be rounded to 94 or 95. Thus, in the enhanced reconstructed frame, the value \hat{x}=94.5 replaces the value (e.g., 100) of the current pixel 704.

While the neighborhood 702 is shown as being a square window, that need not be the case. The neighborhood can have any other shape, such a rectangular, a diamond shape, or any other shape. Additionally, while the neighborhood 702 is shown as being a window of size of 3×3, that need not be the case and other sizes (and shapes) are possible. Appropriate adjustments can be applied to the filtering equation(s) to adapt them to the shape and size of the neighborhood.

The set of weights 706 illustrates an example of a symmetric filter. A symmetric filter refers to a filter whose weights are symmetrically arranged around its center. This means that the weight pattern of the filter is mirrored equally on both sides of the central axis (or point, in the case of a 2D filter applied to images). Symmetric filters can preserve image features such as edges and textures by treating all directions equally around the current pixel (e.g., the pixel 704). In a symmetric filter, given a central pixel (e.g., the pixel 704), the pixels at equal distances from the central pixel in all directions will have the same weight. That is, the weight at position (m, n) is the same as the weight at position (−m, −n). Such symmetry ensures that the filtering effect is uniform across different parts of the image, which is particularly useful for noise reduction and image smoothing without favoring any specific orientation.

As such, due to the symmetry, an encoder need only transmit half of the weights to the decoder and the decoder can infer the other half. To be more specific, the encoder need only transmit the weights for one side of the central pixel in addition to the weight of the central pixel itself. However, if the filter were to be applied using an equation such as (2) or (3), the weight of the central pixel can be assumed to be 0, since as can be observed from those equations, the value of the central pixel is subtracted from itself resulting in a zero value. Accordingly, the weight of the central pixel need not be transmitted.

The set of weights 708 illustrates an example of an anti-symmetric filter. An anti-symmetric filter refers to a filter whose impulse response is anti-symmetric about its central element or point. An anti-symmetric filter can emphasize differences across a central axis, therewith enhancing features such as edges or transitions in intensity by applying weights that have opposite signs on opposite sides of the central point. To illustrate, anti-symmetry in a 2D filter means that if the filter weights are flipped around the central pixel horizontally or vertically, the flipped weights are the negated values of the original weights. Stated another way, given a sequence of filter coefficients, the coefficients on one side of the center are the mirror image and negated values of those on the other side. Stated yet another way, each weight outside the center row and column is negated across the center point (0,0), providing the necessary anti-symmetry: f^{(p,q)}(m, n)=−f^{(p,q)}(−m, −n).

FIG. 8 is an example of a flowchart of a technique 800 for filtering (e.g., modifying, adjusting, or the like) pixel values of one color plane using pixels (i.e., the pixel values) of another color plane. The technique 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 800. The technique 800 may be implemented in whole or in part in the loop filtering stage 416 stage of the encoder 400 of FIG. 4 and/or loop filtering stage 512 of the decoder 500 of FIG. 5. The technique 800 can be implemented using specialized hardware or firmware. Multiple processors, memories, or both, may be used.

At 802, a syntax element is coded indicating cross color plane filtering in a filtering stage. That is, the syntax element indicates that pixel values of one color plane are to be filtered using pixel values of another color plane. The syntax element, and as further described below, can be one or more syntax elements. When implemented by the encoder, coding the syntax element means to encode the syntax element in a compressed bitstream, such as the compressed bitstream 420 of FIG. 4. When implemented by the decoder, coding the syntax element means to decode the syntax element from a compressed bitstream, such as the compressed bitstream 420 of FIG. 5. While not specifically shown, the technique 800 may also include coding filter weights (i.e., coefficients) to be used in the filtering. The number of sets of weights may depend on the value of syntax element.

At 804, a filter is applied to at least one pixel value of the one color plane using at least one pixel value of the other color plane. For example, each pixel of the one color plane can be filtered using pixels of the other color plane. The one color plane can be one or more of the Cb or Cr chrominance lanes and the other color plane can be the luminance Y plane. For brevity, filtering the pixel values of the one color plane using pixel values of another color plane is illustrated herein mostly with respect to the Cb and the Y color planes. However, the disclosure is not so limited. That is, any combination of one color plane and another color plane are possible. The one and the other color planes are different.

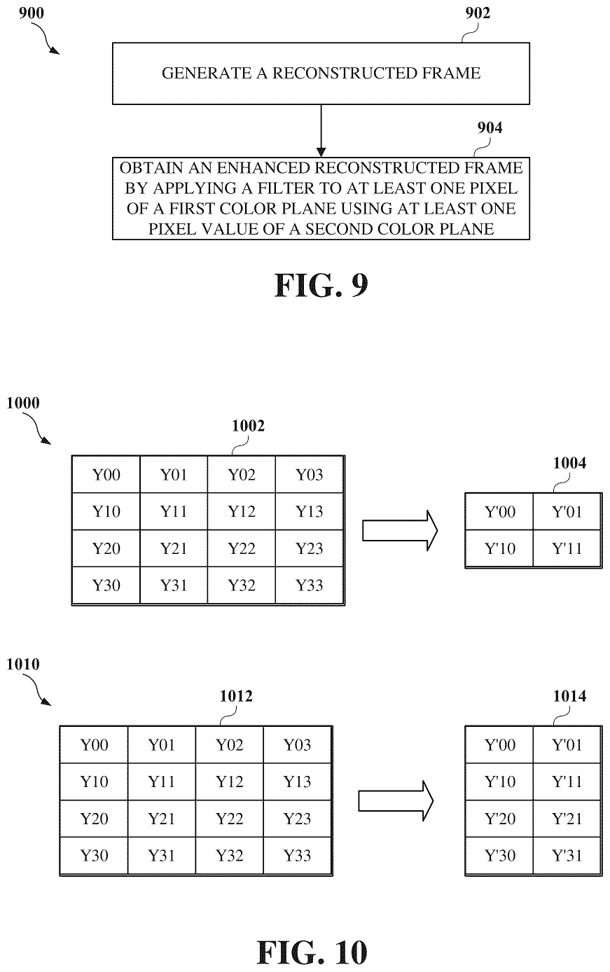

FIG. 9 is an example of a flowchart of a technique 900 for filtering pixel values of one color plane using pixels of other color planes. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 900. The technique 900 may be implemented in whole or in part in the loop filtering stage 416 stage of the encoder 400 of FIG. 4 and/or loop filtering stage 512 of the decoder 500 of FIG. 5. The technique 900 can be implemented using specialized hardware or firmware. Multiple processors, memories, or both, may be used.

At 902, a reconstructed frame is generated. The reconstructed frame is generated by decoding an encoded frame from a compressed bitstream. The reconstructed frame can be generated by the reconstruction stage 414 or by the loop filtering stage 416 of the encoder 400 of FIG. 4. The reconstructed frame can be generated by the reconstruction stage 510 or the loop filtering stage 512 of FIG. 5. As described above, the reconstructed frame can include or be composed of multiple color planes, including a first color plane and a second color plane. For example, with reference to the YUV color space, the first color plane and the second color plane can be any of the combinations (Y, Y), (Y, Cb), (Y, Cr), (Cb, Cb), (Cb, Cr,), (Cr, Cr), (Cr, Cb), and so on. In an example, the first color and the second color planes are different color planes.

At 904, an enhanced reconstructed frame is obtained by applying a filter to at least one pixel of the first color plane of the reconstructed frame using at least one pixel value of the second color plane. The filter can be applied to each pixel of the first color plane using appropriate pixels of the second color plane. The filter can be as described with respect to equation (2). As such, the filter can be a Wiener filter.

Filtering a pixel of the first color plane uses pixels in a window (or, more generally, a neighborhood) centered at the pixel in the first color plane and a co-located pixel and its corresponding window in the second color plane. For illustration purposes, the window is assumed to be a square of size k×k. As alluded to above, the second color plane may have itself been subjected to one or more filters or enhancement tasks. Similarly, the first color plane may itself have already been subjected to one or more filters or enhancement tasks.

For illustrative purposes, the luminance color plane will be used to represent the second color plane, and the Cb color plane will be used to represent the first color plane. However, as described above, the disclosure is not so limited. The Cb pixel values can be filtered by using Y pixel values of a window as inputs, as shown in equation (4), where

$${f}_{Y - > Cb}^{( p , q )}$$

is the set ot weights used when the Cb color plane is filtered using the Y color plane:

$$\text{?} ( p , q ) = Cb ( p , q ) + {\sum }_{m , n = - k / 2}^{( L + 1 ) / 2 - 1} ( Y ( p + m , q + n ) - Y ( p , q ) ) * {f}_{Y - > Cb}^{( p , q )} ( m , n ) \qquad ( 4 )$$

In some situations, the first and the second color planes may have different resolutions, such as in the case where the first color component is the luminance color plane and the second color is a chrominance color plane, or vice versa. This difference in resolutions is typically a result of chroma subsampling, a process used to reduce the amount of data needed to represent an image or video frame by leveraging the human visual system's varying sensitivity to luminance and chrominance details.

In the case of 4:4:4 subsampling, the first and the second color planes have the same resolution. However, the first and the second color planes have different resolutions in the cases of 4:2:2 and 4:2:0 subsampling. In 4:2:2 subsampling, the luma plane is fully sampled, while each of the chrominance planes has half the horizontal resolution of the luma plane; and in 4:2:0 subsampling, the luma plane is fully sampled, but each of the chrominance planes has half the horizontal and half the vertical resolution of the luma plane, resulting in each chrominance plane having one quarter the number of samples of the luma plane.

As such, in the cases of 4:2:2 and 4:2:0 subsampling, the luma color plane is down-sized to the size of the chroma component prior to applying equation (4). That is, in equation (4), Y(p+m, q+n) and Y(p,q) are pixels of the down-sized luminance color plane.

As such, when the first color plane has a lower resolution than the second color plane, applying the filter to at least one pixel of the first color plane of the reconstructed frame using the at least one pixel value of the second color plane, at 904, can include obtaining a down-sized second color plane by down-sizing the second color plane where the at least one pixel value is a pixel of the down-sized second color plane. That is, the down-sized second color plane is used in the filtering instead of the original color plane of the reconstructed image. Obtaining the down-sized second color plane can be obtained in any number ways, including sub-sampling or down-sampling. An example of down-sampling is described with respect to FIG. 10.

Conversely, if the second color plane were a chrominance color plane and the first color plane were the luminance color plane, then the chrominance color plane would have to be up-sized to match the resolution of the luminance color plane. In an example, a chrominance plane may be up-sized to the size of the luminance plane by up-sampling. To illustrate, given a chrominance plane portion of size 2×2 that is to be up-sampled to a luminance plane portion of size 4×4, the chrominance plane portion can be duplicated in both the horizontal and the vertical directions. Other up-sizing technique can be used, such as bilinear interpolation.

In an example, obtaining the enhanced reconstructed frame by applying the filter can include applying a first filter to the first color plane to obtain an intermediate filtered color plane and then applying the filter to the intermediate filtered color plane to obtain the enhanced reconstructed frame. To illustrate, each Cb pixel of the first color plane may be filtered by using the Cb pixel values within the neighborhood (e.g., window) of the each Cb pixel using equation (5) to obtain the intermediate filtered color plane. The set of the pixels [symbol] (p, q) form (e.g., constitute) the intermediate filtered color plane. Subsequently, each [symbol] (p, q) of the intermediate filtered color plane is filtered using the luminance pixel values within the neighborhood (e.g., window) of a co-located Y pixel using equation (6) to obtain the enhanced reconstructed frame:

$$\text{?} ( p , q ) = Cb ( p , q ) + {\sum }_{m , n = - \frac{k}{2}}^{\frac{L + 1}{2} - 1} ( Cb ( p + m , q + n ) - Cb ( p , q ) ) * {f}^{( p , q )} ( m , n ) \qquad ( 5 )$$

$$\text{?} ( p , q ) = \text{?} ( p , q ) + {\sum }_{m , n = - k / 2}^{( L + 1 ) / 2 - 1} ( Y ( p + m , q + n ) - Y ( p , q ) ) * {f}_{Y \to Cb}^{( p , q )} ( m , n ) \qquad ( 6 )$$

As mentioned above, the luminance plane used in equation (6) may be a down-sized luminance plane to match the size of the chrominance Cb color plane.

In some examples, symmetric filters could be used in the equation (3) to (6). As such, in an example, when the Cb pixel values are filtered using Y pixel values of the neighborhood as inputs, such as shown in equation (4) or equation (6), an anti-symmetric filter can be used to, for example, emphasize the high frequency of Y component to enhance the quality of Cb component pixel values. In the anti-symmetric filter, the value of f^{(p,q)}(m, n) is equal to the value of −f^{(p,q)}(−m, −n).

In an example, the Cb pixel values can be filtered by using the Y pixel values of the neighborhood as inputs. An anti-symmetric filter can be applied in addition to a symmetric filter. The Cb pixel value can be first refined with a symmetric filter, and then further refined with an anti-symmetric filter by using the Y pixel values of the neighborhood as inputs. As such, in an example, a symmetric filter (e.g., symmetric filter weights) can be used in equation (5) and anti-symmetric filter (e.g., anti-symmetric filter weights) can be used in equation (6). That is, symmetric weights may be used by the first filter and anti-symmetric weights may be used by the filter (e.g., a second filter). Two different sets of weights may be used (e.g., coded).

In an example, the Cb pixel values can be first refined with symmetric filters by using the Cb pixel values of the neighborhood and the Y pixel values of the neighborhood as inputs, and then further refined with an anti-symmetric filter by using the Y pixel values of the neighborhood as inputs. As such, obtaining the enhanced reconstructed frame by applying the filter, at 904, can include applying a first filter to the first color plane to obtain a first intermediate filtered color plane, where the first filter uses symmetric weights. A second filter is then applied to the first intermediate filtered color plane to obtain a second intermediate filtered color plane, where the second filter is applied to at least one pixel of the first intermediate filtered color plane using at least one pixel value of the second color plane, and where the second filter uses symmetric weights. The filter (e.g., a third filter) is then applied to the second intermediate filtered color plane to obtain the enhanced reconstructed frame, wherein the filter uses anti-symmetric weights. As such, three different sets of weights may be used (e.g., coded).

In an example, the technique 900 can include coding a syntax element indicating to apply the filter. That is, when the technique 900 is implemented by an encoder, the syntax element is encoded into a compressed bitstream; and when implemented by a decoder, the syntax element is decoded from the compressed bitstream. Weights for filters described above can also be coded. For example, the encoder may encode the weights in the compressed bitstream; and the decoder may decode the weights from the compressed bitstream. Whether a filter to be applied is symmetric or anti-symmetric can also be coded.

As already mentioned, while equations (3)-(6) above are described with respect to the chrominance blue Cb color plane, the disclosure is not limited and the pixel values of the chrominance blue Cb color plane can be similarly obtained. Furthermore, the disclosure is not limited to the YUV color space. The same or similar techniques and equations can be used with pixel values of components of other color spaces. As such, in general, all equations (3)-(6) can be adapted to apply for filtering process of the pixel values of any two components or any color space.

In an example, a first syntax element may be coded indicating whether the chroma Cb color plane is to be filtered based on the luminance Y color plane. The syntax element may have a first value (e.g., 00) indicating no filtering, a second value (e.g., 01) indicating that filtering is to be performed with symmetric weights, a third value (e.g., 10) indicating that filtering is to be performed with anti-symmetric weights, and a fourth value (e.g., 11) indicating that filtering with symmetric weights followed by filtering with anti-symmetric weights are to be performed. Corresponding weights, if any, are also coded. A second syntax element may also be coded indicating whether the chroma Cr color plane is to be filtered based on the luminance Y color plane. The second syntax element can have the same values as those of the first syntax element.

FIG. 10 illustrates examples of down-sizing a frame. Specifically, the examples shown illustrate down-sampling. However, a down-sized framed may be obtained by sub-sampling, such as by retaining some of pixels of the frame and discarding others. Down-sizing may be performed with respect to a luminance (Y) frame to match the size of chrominance planes (Cb and Cr).

An example 1000 illustrates down-sampling in the case of a 4:2:0 subsampling scheme. The example 1000 includes a luma plane portion 1002 that is a portion of a larger luma plane. The luma plane portion 1002 is to be down-sampled into down-sampled luma plane portion 1004 that matches a 2×2 chroma resolution since the chrominance planes have half the horizontal and vertical resolution of the luminance plane.

In an example, to down-sample the luma plane portion 1002 to the 2×2 resolution, every 2×2 block can be averaged to obtain a corresponding pixel of the down-sampled luma plane portion 1004. While averaging can help to preserve the overall brightness while reducing the resolution, other ways of combining the pixel values are possible. Thus, the pixel values of the down-sampled luma plane portion 1004 can be obtained as follows:

$${Y}^{′} 00 = ( Y 00 + Y 01 + Y 10 + Y 11 ) / 4$$

$${Y}^{′} 01 = ( Y 02 + Y 03 + Y 12 + Y 13 ) / 4$$

$${Y}^{′} 10 = ( Y 20 + Y 21 + Y 30 + Y 31 ) / 4$$

$${Y}^{′} 11 = ( Y 22 + Y 23 + Y 32 + Y 33 ) / 4$$

An example 1010 illustrates down-sampling in the case of a 4:2:2 subsampling scheme. The example 1010 includes a luma plane portion 1012 that is a portion of a larger luma plane. The luma plane portion 1012 is to be down-sampled into down-sampled luma plane portion 1014 that matches a 4×2 chroma resolution since the chrominance planes have half the horizontal and the same vertical resolution of the luminance plane. Averaging is used again. As such, the pixel values of the down-sampled luma plane portion 1004 can be obtained as follows:

$${Y}^{′} 00 = ( Y 00 + Y 01 ) / 2$$

$${Y}^{′} 01 = ( Y 02 + Y 03 ) / 2$$

$${Y}^{′} 10 = ( Y 10 + Y 11 ) / 2$$

$${Y}^{′} 11 = ( Y 12 + Y 13 ) / 2$$

$${Y}^{′} 20 = ( Y 20 + Y 21 ) / 2$$

$${Y}^{′} 21 = ( Y 22 + Y 23 ) / 2$$

$${Y}^{′} 30 = ( Y 30 + Y 31 ) / 2$$

$${Y}^{′} 31 = ( Y 32 + Y 33 ) / 2$$

For simplicity of explanation, the techniques 800 and 900 of FIGS. 8 and 9, respectively, are each depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, an (e.g., non-transitory) computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. A method, comprising:
generating a reconstructed frame by decoding an encoded frame from a compressed bitstream, wherein the reconstructed frame comprises a first color plane and a second color plane; and
obtaining an enhanced reconstructed frame by applying a filter to at least one pixel of the first color plane of the reconstructed frame using at least one pixel value of the second color plane.

2. The method of claim 1, wherein the first color plane has a lower resolution than the second color plane, and wherein applying the filter to the at least one pixel of the first color plane of the reconstructed frame using the at least one pixel value of the second color plane comprises:
obtaining a down-sized second color plane by down-sizing the second color plane, wherein the at least one pixel value is a pixel of the down-sized second color plane.

3. The method of claim 1, wherein obtaining the enhanced reconstructed frame by applying the filter comprises:
applying a first filter to the first color plane to obtain an intermediate filtered color plane; and
applying the filter to the intermediate filtered color plane to obtain the enhanced reconstructed frame.

4. The method of claim 3, wherein the first filter uses symmetric weights, and the filter uses anti-symmetric weights.

5. The method of claim 1, wherein obtaining the enhanced reconstructed frame by applying the filter comprises:
applying a first filter to the first color plane to obtain a first intermediate filtered color plane, wherein the first filter uses first symmetric weights;
applying a second filter to the first intermediate filtered color plane to obtain a second intermediate filtered color plane, wherein the second filter is applied to at least one pixel of the first intermediate filtered color plane using the at least one pixel value of the second color plane, and wherein the second filter uses second symmetric weights; and
applying the filter to the second intermediate filtered color plane to obtain the enhanced reconstructed frame, wherein the filter uses anti-symmetric weights.

6. The method of claim 1, further comprising:
coding a syntax element indicating to apply the filter.

7. The method of claim 1, further comprising:
coding weights for the filter.

8. The method of claim 7, further comprising:
coding a syntax element indicating whether the filter is a symmetric or an anti-symmetric filter.

9. The method of claim 1, further comprising:
coding a syntax element indicating to apply a symmetric filter and to apply an anti-symmetric filter.

10. The method of claim 1, wherein one of:
the first color plane is a luminance plane, and the second color plane is a chrominance blue plane; or
the first color plane is a luminance plane, and the second color plane is a chrominance red plane.

11.-14. (canceled)

15. A non-transitory computer-readable storage medium having stored thereon an encoded bitstream, wherein the encoded bitstream is configured for decoding by the method of claim 1.

16. (canceled)

17. A device, comprising:
a processor configured to:
generate a reconstructed frame by decoding an encoded frame from a compressed bitstream, wherein the reconstructed frame comprises a first color plane and a second color plane; and
obtain an enhanced reconstructed frame by applying a filter to at least one pixel of the first color plane of the reconstructed frame using at least one pixel value of the second color plane.

18. The device of claim 17, wherein the first color plane has a lower resolution than the second color plane, and wherein applying the filter to the at least one pixel of the first color plane of the reconstructed frame using the at least one pixel value of the second color plane comprises:
obtaining a down-sized second color plane by down-sizing the second color plane, wherein the at least one pixel value is a pixel of the down-sized second color plane.

19. The device of claim 17, wherein to obtain the enhanced reconstructed frame by applying the filter comprises to:
apply a first filter to the first color plane to obtain an intermediate filtered color plane; and
apply the filter to the intermediate filtered color plane to obtain the enhanced reconstructed frame.

20. The device of claim 19, wherein the first filter uses symmetric weights, and the filter uses anti-symmetric weights.

21. The device of claim 17, wherein to obtain the enhanced reconstructed frame by applying the filter comprises to:
apply a first filter to the first color plane to obtain a first intermediate filtered color plane, wherein the first filter uses first symmetric weights;
apply a second filter to the first intermediate filtered color plane to obtain a second intermediate filtered color plane, wherein the second filter is applied to at least one pixel of the first intermediate filtered color plane using the at least one pixel value of the second color plane, and wherein the second filter uses second symmetric weights; and
apply the filter to the second intermediate filtered color plane to obtain the enhanced reconstructed frame, wherein the filter uses anti-symmetric weights.

22. The device of claim 17, wherein the processor is configured to code a syntax element indicating to apply the filter.

23. The device of claim 17, wherein the processor is configured to code weights for the filter.

24. The device of claim 23, wherein the processor is configured to code a syntax element indicating whether the filter is a symmetric or an anti-symmetric filter.

25. The device of claim 17, wherein the processor is configured to code a syntax element indicating to apply a symmetric filter and to apply an anti-symmetric filter.
